(19) United States
(12) Patent Application Publication
(10) Pub. No.: US 2010/0293045 A1
(43) Pub. Date: Nov. 18, 2010

(54) Centralized Renewable Energy System With Fractional Ownership and a Method of Disaggregated Net Metering of its Renewable Energy Output Among Utility Customers Who Are Fractional Owners

(76) Inventors: James Moeller Burns, Austin, TX (US); Thomas Warren Burns, Austin, TX (US)

Correspondence Address: VINSON & ELKINS, L.L.P., FIRST CITY TOWER, 1001 FANNIN STREET, SUITE 2500, HOUSTON, TX, 77002-6760, US

(21) Appl. No.: 12/780,755

(22) Filed: May 14, 2010

Related U.S. Application Data
(60) Provisional application No. 61/178,480, filed on May 14, 2009.

(51) Int. Cl. G06Q 50/00; G06Q 30/00; G06Q 10/00

(52) U.S. Cl. 705/14.11; 705/34

(57) ABSTRACT

Systems and methods for off-site centralized renewable energy generation systems for utility customers to remotely generate renewable energy that can be credited to their utility bill at their residence or place of business. Fractional ownership of a centralized facility provides cost savings through economies of scale and allows fractional owners to receive all available tax incentives for renewable energy production.

### CROSS REFERENCE TO RELATED APPLICATIONS

This application claims benefit of priority to U.S. Provisional Application Ser. No. 61/178,480, filed May 14, 2009, the entire contents of which are incorporated herein by reference for all purposes.

### FIELD

The present disclosure relates in general to renewable energy systems, and more particularly, to a centralized renewable energy generation system for utility customers to remotely generate renewable energy that can be credited to their utility bill at their residence or place of business.

### BACKGROUND

Renewable energy generation, and wind and solar energy systems in particular, are becoming more economically feasible due to 1) continuing innovations and 2) support through governmental and utility-based incentives. These renewable energy systems by their nature are not demand-based. They only produce electrical energy when the wind blows or the sun shines. Wind and solar energy systems can be either stand-alone or electrical grid-connected. Stand-alone systems are prevalent in remote areas without traditional grid-based electrical service, and usually involve local storage of energy to balance time of consumption with time of production. Grid-connected renewable energy systems predominate in traditional service areas, where the renewable energy from onsite installations, when available, is used by customers to offset individual utility grid energy consumption and reduce their electric bills. When the renewable energy system is not producing, electric energy from the grid is used by the customers.

Utility customers with onsite renewable energy systems may be categorized as either commercial or residential customers. Commercial customers are further categorized by their taxable or tax-exempt status. Residential site systems are typically owned or leased by individuals.

Of particular importance to the adoption of onsite renewal energy installations by electric utility customers are governmental regulatory policies relating to “Net Metering”. An onsite commercial or residential grid-connected renewable energy system is defined as being on the customer (rather than the utility) side of the customer's electrical meter that monitors the customer's electrical energy consumption. These systems are physically placed at the customer site, and are used to offset the customer's local electric use from the electric utility. If the local power generation exceeds the local consumption, the excess is fed back to the utility's grid, in reality turning the customer's meter backward. In many regulatory jurisdictions in this country, this results in giving the customer a credit due to its onsite energy generation at the utility's retail or avoided cost price of electricity. Another way of looking at this is the utility's electrical grid functions as an energy storage battery for the onsite renewable system with almost 100% efficiency.

Net Metering may be performed on the customer's site with either a bi-directional meter, or a pair of meters—each metering to and from the utility's grid. While in general renewable energy systems are designed to not exceed the local generator's baseline load, in the event the onsite renewable energy system produces more energy than it consumes on a short-term basis, the applicable Net Metering government regulatory or utility-based policy permits the local customer to have credited to its billing account the excess generated electrical energy, either at the utility's retail rate or the applicable avoided cost rate; provided that over a longer requisite period, such as a month or year, the local customer is not a net exporter of generated electrical energy to the grid.

There remain many obstacles, however, to the adoption of renewal energy systems by both residential and commercial customers of electric utilities. Under existing governmental rules and utility tariffs, if a customer with an onsite renewable energy system decreases its consumption due to conservation or other changes of status or if it becomes a net generator of energy over a long time period, the excess electricity is simply given to the utility for no compensation, or is credited at a low rate. Currently, there is no easy means for an existing customer with an onsite renewable energy system to transfer the electrical energy to someone else that may desire to have it. Such a customer with an onsite system would have to disassemble the excess portion of their system and reinstall it at the other location, at considerable costs.

Another major barrier to the adoption of wind or solar renewable energy systems is the suitability of the customer site. Onsite wind power is generally only attractive in nonurban areas. Detractors cite noise, harm to wildlife, and unsightly towers subject to zoning height restrictions as the primary objections.

Urban solar energy installations by commercial customers have encountered more success. Commercial customers, such as large, customer-owned real-estate complexes are experiencing dramatic growth in solar photovoltaic (“PV”) panel installations. These kinds of commercial sites have large roofs and parking lots on which to place the solar PV systems. Good economies of scale are realized due to the large installed size of these solar PV systems. But for most commercial businesses that lease office, retail or manufacturing facilities, there is generally no onsite space available for installing either wind or solar PV systems to reduce their electric bills. Such commercial customers typically cannot place solar PV systems on their roof, because they do not own the building and an owner typically will not permit lessees to install such systems.

Although residential solar PV installations are more suitable than wind installations to urban areas, there has been only limited adoption of such solar PV systems. Most existing incentive programs require an onsite survey to qualify for rebates or tax-based incentives, which quantifies the suitability of a site for a solar PV system. Unfortunately, there is a significant percentage of the market for solar PV systems that simply do not qualify due to problems with the proposed site.

For example, such installations require a significant physical area on which to place the PV panels—either a stand-alone mounting system or on the roof. To ensure a minimum level of efficiency in order to qualify for governmental- or utility-based incentives, the panels must be placed with a southern-facing exposure for installations in the northern hemisphere, optimally at a angle which is a function of the latitude of the installation. (The efficiency can be increased by adding one or two axis tracking systems to present the solar PV panels orthogonally to the sun's rays at all times. This is seldom done in past residential roof installations due to the added complexity and the increased static and dynamic (wind) loads that would be placed on the structure's roof.)

Stand-alone solar systems generally require too much of the square footage of the typical residential site to be economically attractive in urban areas. In addition, shade from trees and other vegetation, hills, and other structures need to be minimized; however the reduction of vegetation to permit the siting of a solar PV system is contrary to green building practices, which in warmer climates encourage the occupant to shade a residence with tall vegetation to reduce cooling bills.

There are numerous other disadvantages to onsite solar PV systems. Even if a residential site is suitable for installing a solar PV system, many individuals believe a roof mounted solar PV system is unappealing visually, and many homeowners associations and subdivision deed restrictions prohibit or restrict their installation. An individual who otherwise is an excellent candidate for a solar PV system may also not wish to place the system on an expensive tile roof. In addition, roof-based solar PV installations require removal in the event the roof needs replacement. While solar PV systems are typically warranted for 25-30 years, most composition shingle roofs only last 10-15 years, thereby requiring the added expense of removing and replacing the solar PV system before the end of its design life.

Operating and maintenance costs for roof-installed solar PV systems are higher than utility-scale solar PV systems. Leaves and debris cannot be allowed to build up between the solar panels and the roof. The solar panels must be cleaned to remove any dirt or natural aerosols that settle on them, reducing their efficiency and electrical output. Squirrels or other animals may chew on electrical cables.

Another disadvantage with residential-installed solar PV systems is what happens to the systems in the event the owners move. In one view, ownership of the installed system conveys with the underlying structure and real estate as a fixture. In this case, the original owners would have to purchase and install a new solar PV system at their new residences if they wished to continue to receive the benefits of renewable energy. If ownership of the installed system does not convey with the residence, then the installed system would have to be dismantled and reassembled at the person's new residence.

Another disadvantage for a customer onsite solar PV system is the large front-end costs. Total solar PV system costs include the costs of the PV panels, the mounting hardware, the inverters that convert the DC output of the panels to grid-compatible AC voltage, installation costs, and operating and maintenance costs. System installation costs are typically reported in dollars per installed kilowatt peak ($/kWp).

Residential-scale solar PV systems typically have significantly higher costs per installed kWp than larger, utility-scale, centralized solar PV systems. Therefore, residential owners do not participate in the economies of scale found in the utility-scale installations. Also, local engineering costs, site survey and site placement costs, and costs associated with the difficulty of roof access are spread across a smaller amount of installed power.

The higher installation costs associated with residential renewable systems, and solar PV in particular, highlight another problem—the problem of economic justification. Solar PV energy is expensive to acquire, but has no ongoing fuel cost, limited maintenance costs, and zero carbon emissions. As such, adoption of renewable energy is recognized as beneficial to the nation. While one can voluntarily choose to purchase their electric energy from renewable sources, mass adoption of distributed renewable energy systems will not occur unless the cost of energy from the renewable energy system is lower than from traditional utility sources. For this reason, there is a wide range of governmental and utility-based incentives designed to reduce the up-front costs and facilitate the adoption of renewable energy.

Both commercial and residential customers with onsite renewable energy systems enjoy the benefit of these incentives. At present, there are two federal tax credits based upon the installed cost for the renewable energy system, an investment tax credit for businesses, and a residential renewable energy tax credit for individuals. As previously discussed, many state and local governments have issued regulations that provide for Net Metering. Many utilities provide a capacity-based incentive, expressed as $/Watt, which is a rebate based on the installed capacity of the renewable energy system. Governmental entities and utilities are also moving to performance- or production-based incentives, which are typically cash incentives paid over time based upon how efficient a system is at delivering energy.

These incentives for customer based renewable energy systems are designed to increase the adoption of renewable energy, by driving down up-front costs and ultimately reducing the customer's electric bill by avoiding a purchase from the utility. But under the traditional view that the renewable energy system has to be behind the meter at the customer's site, these incentives are not available to either commercial or residential customers if their site is not suitable for either a wind or solar energy installation.

Even after the application of financial incentives, there remains a portion of the installation costs of which the commercial and residential customers with onsite systems either pay out of pocket, or finance for some period of time. These costs are a barrier to mass adoption of customer-based renewable energy systems. Most consumers either don't have or are not willing to pay out of pocket for these systems, so some financing mechanism must be used. However, the ability of such customers to obtain traditional financing is constrained by the lender's inability to collateralize the loan. Since onsite systems are customized, and a large portion of the cost relates to their installation, it is difficult to for the lender to have confidence that it can foreclose on a solar PV system separate from the commercial or residential structure on which it is mounted. In addition, there is a net present value related to the ongoing cash flow associated with the utility savings generated by onsite renewal energy systems; however there is no mechanism to foreclose on this revenue stream if there is no one in a position to consume the electricity generated. Therefore, financing is difficult to obtain, and the financing periods are too short for the renewable energy system to generate sufficient net savings for the customer within a sufficiently short time period.

Accordingly, there is a need for a workable centralized renewable energy system for customers to remotely generate renewable energy, obtain renewable energy incentives in connection therewith, and whose energy output can be credited to their utility bill at their residence or place of business.

### SUMMARY

The present disclosure includes systems and methods for providing input of energy from a renewable power source into a utility grid from a centralized off-site renewable energy source. The disclosed systems and methods provide opportunities for homes or businesses without the ability to install renewable energy systems such as solar panels or wind turbines on site to benefit from the use of renewable energy. Urban dwellers or businesses, for example, are able to buy a fractional ownership of a centralized off-site facility that is a mortgagable and transferable property that provides the benefit of economy of scale in the initial installation and further provides the owner with the ability to collect all tax incentives available for renewable energy production, thus further reducing the required investment.

In certain embodiments the disclosed systems and methods include one or more advanced metering infrastructure (AMI) compatible power meters at the off-site source location electrically linked to one or more renewable energy production devices and electrically linked to the utility grid, wherein the power meter output is disaggregated by the utility company's billing system to credit a predetermined fraction of the total energy output to each owner's account by aggregation summing of the energy use indicated by each owner's utility meter less the credit due each owner from the off-site renewable energy source power meter.

As used herein, the term off-site has its normal meaning and as applied to off-site energy production refers to a production facility that produces energy that is credited to the utility bill for a residence or business address but in which the energy production does not occur at that address.

The present disclosure also includes systems and methods for the purchase, sale and management of an off-site renewable energy production facility. The management services include but are not limited to managing and maintaining the off-site facility, monitoring energy production of the facility, interfacing with the utility company to manage billing and credits including utility bill aggregation, interfacing with taxing agencies to manage tax incentive transactions, maintaining and enforcing power pooling agreements between owners, maintaining records and bylaws of an owner's association, and managing and maintaining any commonly owned or association owned property at the off-site renewable energy production facility.

### BRIEF DESCRIPTION OF DRAWINGS

For a more complete understanding of the present disclosure, and the advantages thereof, reference is now made to the following descriptions taken in conjunction with the accompanying drawings, in which:

FIG. 1 is a diagrammatic representation of a residence site with an On-Site Renewable Energy System (shown as a solar photovoltaic energy system), and its relationship to an electric utility grid that has implemented the Advanced Metering Infrastructure, a component of the “smart grid”;

FIG. 2 is a diagrammatic representation of the system as shown in FIG. 1, but where the components of the Renewable Energy System have been relocated to a site more conducive to optimal system operation (termed “Off-Site”), and where a management, monitoring & maintenance company is added;

FIG. 3A is a diagrammatic representation of a Meter Aggregation mechanism, which generates a Net Usage calculation, so that the utility bill for the residence site with the Off-Site system reflects the energy generated by the Renewable Energy System;

FIG. 3B is a diagrammatic representation of the Meter Aggregation mechanism generalized for use with a off-Site Renewable Energy System for providing renewable energy to multiple residences;

FIG. 4 is a diagrammatic representation of the system as shown in FIG. 2, wherein the off-Site Renewable Energy System is designed to provide off-site renewable energy generation for multiple residences. The Off-Site Renewable Energy System shown could be located on a single tract of land, or could be geographically dispersed to multiple locations;

FIG. 5 is a diagrammatic representation of the system as shown in FIG. 4, wherein the entire system is located at a single off-site location, and potentially redundant components, such as individual meters and communications links, are eliminated. This arrangement, typically known as a “solar farm”, can range in size from a small renewable energy system handling a few residences, to a “utility scale” system suitable for serving thousands of residences wherein the ownership of various energy generating components are allocated to the participating residences, but undivided ownership of the shared components is contemplated;

FIG. 6 is a diagrammatic representation of the system as shown in FIG.-5, except that the residences have undivided ownership interests in the Off-Site Renewable Energy System;

FIG. 7 is a diagrammatic representation of a Meter Disaggregation mechanism in combination with Meter Aggregation, so that for each residential owner having an ownership interest in the off-Site Renewable Energy System, Net Usage calculation of the residence's utility bill is generated which reflects such residence's energy contribution from the Off-Site system;

FIG. 8 is an example of Residential Power Usage for a typical summer day, which presents the real-time relationship between the typical residential usage, power generated by a 6 kW solar PV system with typical summer insulation, and the Net Usage after the contribution of the PV Renewable Energy System;

FIG. 9 is a block diagram of the structure of the software systems used to implement the methods of the present disclosure, monitor and control the apparatus of the present disclosure, and to integrate and coordinate with all necessary external systems;

FIG. 10 is a block diagram of the various entities which may be involved in the implementation of the methods of the present disclosure and the control of the apparatus of the present disclosure as shown in FIG. 9; and

FIG. 11 is a flow diagram of the process implemented by the software system to sell and perfect a property interest in the off-site Renewable Energy System.

### DETAILED DESCRIPTION OF THE ILLUSTRATIVE EMBODIMENTS

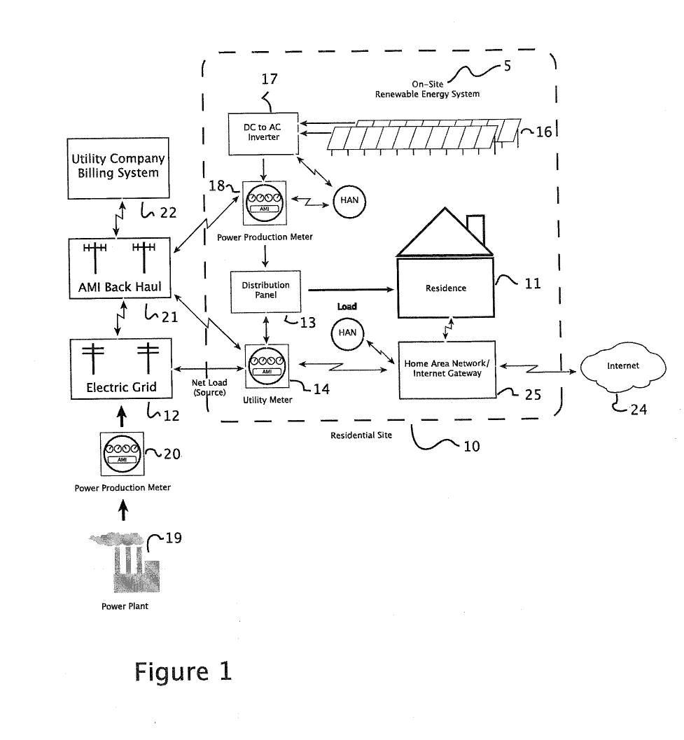

The principles of the present disclosure and their advantages are best understood by referring to FIGS. 1-11.

FIG. 1 presents prior art and illustrates a Site 10 having a Residence 11 of a typical customer of an electric utility which purchases electricity from the electric utility. In a manner well known in the art, Residence 11 is connected to the electric grid 12 of the local electric utility though distribution panel 13 and utility meter 14. The electrical load of Site 10 is measured by meter 14. In the present state of the art, a customer owning the Site 10 and Residence 11 that desires to generate renewable energy to reduce the Site's energy usage from the electric utility may install an onsite Renewable Energy System 5 to locally generate energy from either a wind or solar energy generation system. For a Residence in a large urban area, this System 5 may be a solar energy generation system having photovoltaic (PV) solar panels 16 of suitable design and a DC to AC inverter 17. The solar panels may be roof mounted on the Residence 11 or surface mounted on the Site 10. The solar panels 16 produce direct current (“DC”) that is converted to alternating current (“AC”) by the DC to AC inverter 17, then passes through and is measured by power production meter 18. The utility meter 14 and the power production meter 18 support the Advanced Metering Infrastructure, or AMI. The Advanced Metering Infrastructure is a generic term that refers to systems that provide two-way communication between a meter and a host utility, and optionally a local network. The infrastructure includes the metering devices, and the communications, hardware and software systems that enable them to respond in real time or on a scheduled basis. In general, an AMI meter can participate on both a private utility net work to enable smart grid operations (such as reporting system outages), as well as on a local Home Area Network, such as the IEEE 802.15.4 standard with the ZigBee protocol, to provide consumer visibility to energy usage.

The output of the onsite Renewable Energy System 5 may be connected both to the Residence and the electric grid through distribution panel 13. (Also included, but not shown, are circuit breakers, disconnects and other components required by the utility operating the grid or the applicable regulatory authorities to connect to the electric grid 12.) This basic configuration of the connection of the onsite renewable energy system 5 to the grid 12 is known as a “behind the meter” connection.

The electric grid 12 may provide electricity to the Residence 11 and other similar structures from a variety of base-load or peaking load electrical energy sources also connected to the grid 12. In FIG. 1 the utility's sources of capacity and energy for its electric grid 12 is represented by power plant 19, which for illustration purposes only is shown as a base-load coal-fired power plant. In its simplest form, power plant 19 generates electricity, the amount of which is measured by meter 20 and which is provided to the electric grid 12 in a manner well known in the art.

The solar panels 16 of the Renewable Energy System 5 produce electrical energy when the sun shines on the panels. At night, the energy output of the panels is essentially zero. In this case, the entire electric load of Residence 11 is supplied by electric grid 12 and the cumulative amount of usage, usually expressed in kilowatt hours (kWh), is measured by meter 14.

During daylight hours, Renewable Energy System 5 begins to generate power, which is used by Residence 11, causing the amount of electric energy to be supplied by the grid 12 to be reduced. If the amount of energy supplied by Renewable Energy System 5 equals the electrical load of Residence 11, the amount of energy flowing through meter 14 is zero. In the event the amount of energy supplied by Renewable Energy System 5 exceeds the load of Residence 11, the excess energy passes through Meter 14 and flows into the grid 14 to be used by others. This causes meter 14 to “run backwards”, and record a “negative usage”. On any given day, energy may flow out of or into the grid 12. At the end of a billing period for grid-delivered electrical energy, meter 14 is read, and the net amount of energy used is calculated by subtracting from the current reading the reading at the beginning of the billing period. This is known as “Net Metering”. Production meter 18 is not involved in this calculation, but exists so that the output of Renewable Energy System 5 can be known for status monitoring purposes.

It should be noted that other categories of utility customers typically connected to the grid 12, including commercial sites, may install Renewable Energy Systems 5 on their Sites 10. In addition, condominium owners may be able to install a Renewable Energy System 5 on the roof of their condominiums although the sites on which the condominiums are located maybe owned by a condominium association of which each condominium owner is a member. Accordingly, for the purposes of the present disclosure the term Site 10 may mean (unless a different meaning is otherwise indicated from the context of its use) either a residential, commercial, industrial, or other site, and the term Residence 11 may mean a single family dwelling, a condominium, apartment, and other type of structures which need electricity.

Meters 14 and 18 are preferably compatible with the Advanced Metering Infrastructure (AMI) requirements and are read electronically by the Advanced Metering Infrastructure, typically by a two-way communications link between meters 14 and 18 and the AMI “back haul” 21. This information is collected at neighborhood and community points and is transmitted via a private network to the utility's billing system 22, for the generation of the utility bill for Residence 11. For configurations without the Advanced Metering Infrastructure, these meters can be read manually, with the information presented directly to the billing system 22. Other information, specifically the energy generated by and status of inverter 17, and the consumption of air conditioning units, lights, refrigerators, washer/dryers, etc. in Residence 11 can be collected by the Home Area Network (HAN)/Internet Gateway 25 and transferred to the MM&M company 23 for several useful calculations and reports. In addition, the meter readings from meters 14 and 18 are also available to the HAN as a part of the capabilities of an Advanced Metering Infrastructure implementation.

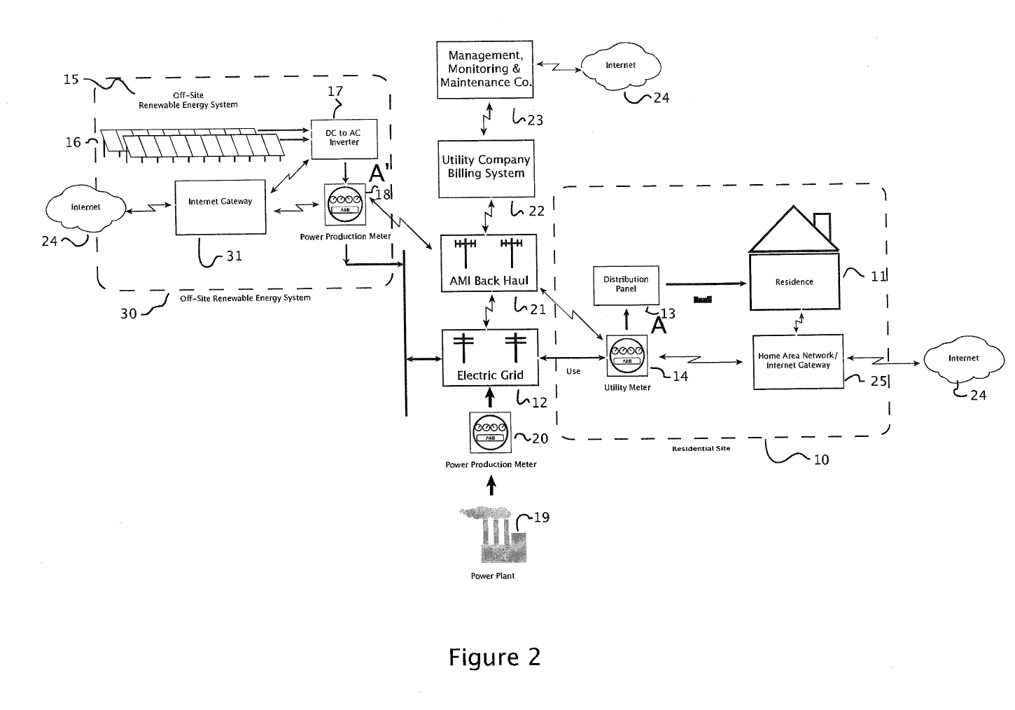

FIG. 2 depicts one embodiment of the present disclosure in which the Renewable Energy System 5 (now designated as Renewable Energy System 15) for the Residence 11 is relocated and installed some distance away at a Site 30, which is more optimal than Site 10 for the particular type of Renewable Energy System 5 desired by the customer. Internet gateway 31may be added to facilitate communication with a management, monitoring and maintenance (“MM&M”) company 23 which manages, monitors, and maintains the Renewal Energy System and its interfaces with the utility and the Residences. In one implementation of the disclosure, Site 30 and Renewable Energy System 15 are owned by the occupant of Residence 11 on Site 10. The tract of land represented by Site 30 on which Renewable Energy System 15 is placed may be owned, leased or otherwise encumbered by the occupant of Residence 11.

In this embodiment, meter 14 will register a usage, and production meter 18 will continue to register energy production. The energy placed on the grid 12 at Site 30 is intended to offset the energy used from the grid at Site 10. Site 30 is preferably chosen so that the distribution line losses and congestion are minimal relative to the Residence location, and the utility is indifferent to whether Renewable Energy System 15 is placed behind the meter 14 or at Site 30. Since the Renewable Energy System 15 is no longer behind the meter 14, a reading of meter 14 reflects only the consumption at Residence 11, and can no longer be considered “Net Metering”.

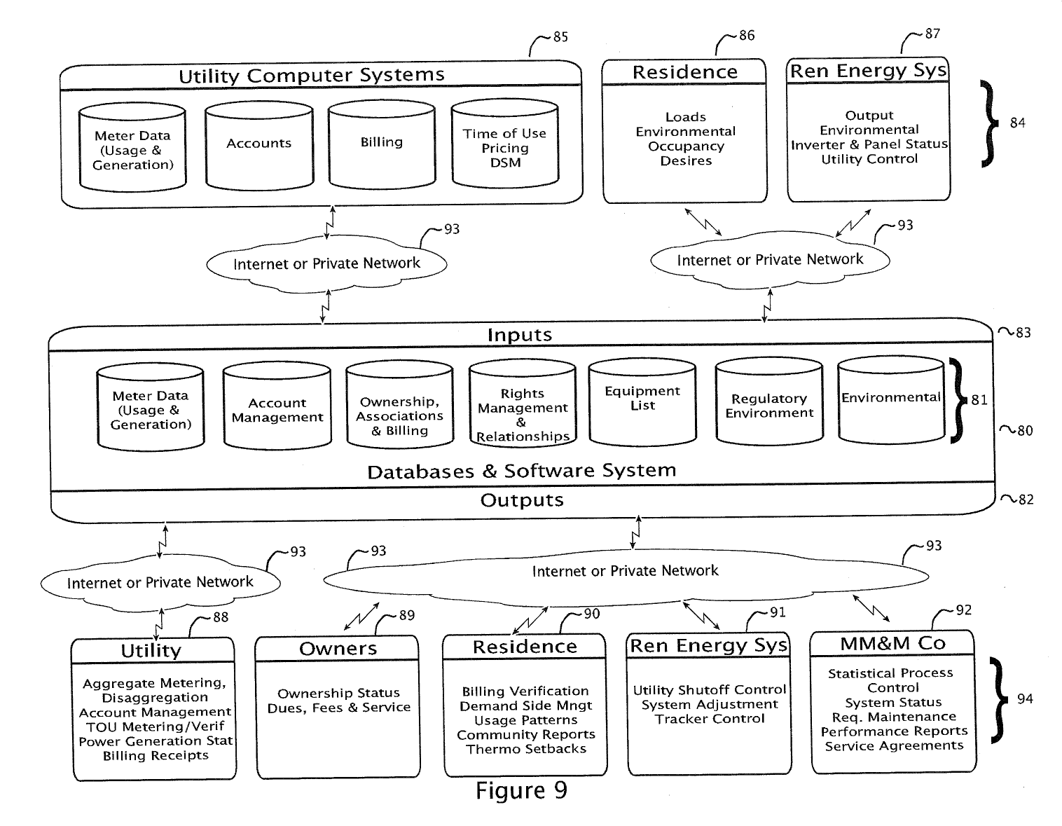

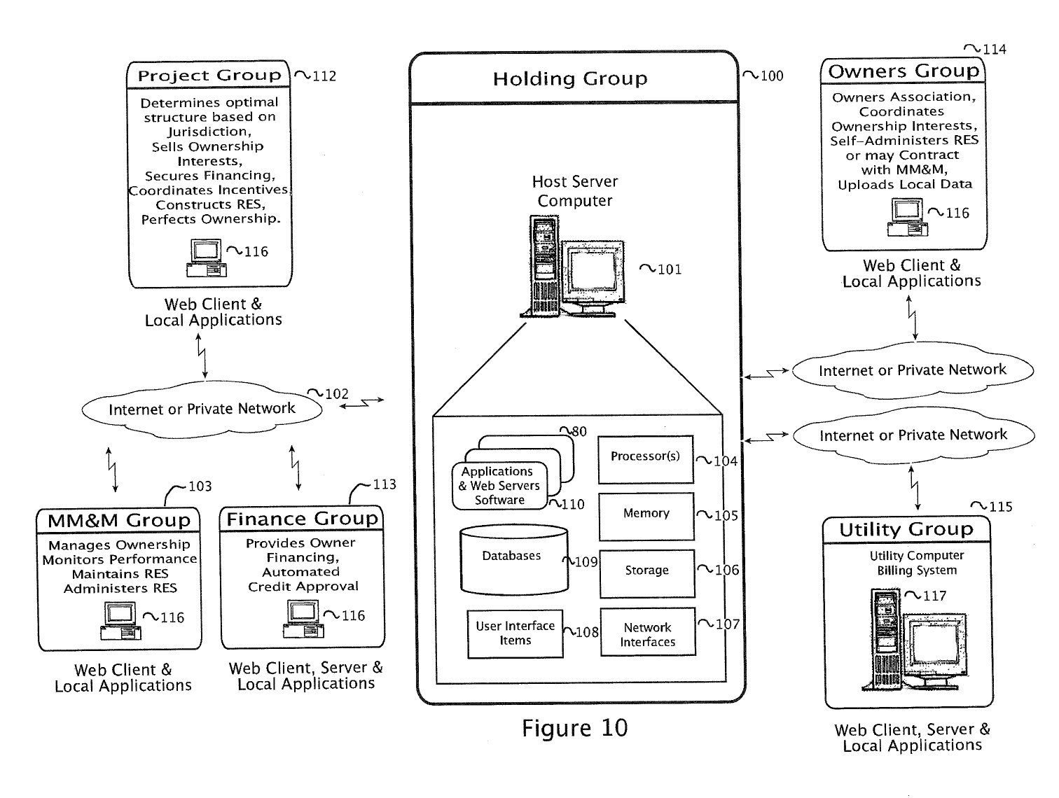

In order for the customer at Residence 11 to receive the benefit of the off-site Renewable Energy System 15 on Site 30 on its utility bill as if it was Net Metered, the MM&M Company 23 may be retained by the owner of Renewable Energy System 15. The MM&M company interfaces with the utility's billing system 22 to collect usage information from meters 14 and 18 through AMI back haul 21. MM&M company 23 directs the utility's billing system 22 to credit the energy generated by System 15 and measured by meter 18 to the utility account represented by meter 14 and Residence 11. The direction is performed using programmable computers programmed as described hereinafter and as depicted in FIGS. 9 and 10 hereof, utilizing the mechanism preferred by the utility's billing system 22. These mechanisms preferably include EDI (Electronic Data Interchange) transfers, or common HTTP or HTTPS protocols such as SOAP (Standard Object Access Protocol). These transfer mechanisms are typically transaction based, as opposed to direct database calls. The MM&M company 23 may also be involved in the event the owner of Off-Site Renewable Energy System 30 moves from his current Residential Site 10. In this case the MM&M company 23 directs the utility's billing system 22 to credit the energy generated by System 15 and measured by meter 18 to the new utility account represented by a new meter (not shown) at the new Residential Site (not shown). This aspect of the disclosure de-couples the Renewable Energy System from the Residential Site, providing portability and transferability, greatly easing the ability to buy, sell and transfer the Renewable Energy System.

The readings of production meter 18 and utility meter 14 can be transferred to the billing system 22 in several ways, including manually, by transmission through the AMI backhaul 21, or via secure transfer from Internet gateways 25 and 31 to MM&M company 23, then via secure transfer from MM&M company 23 to the utility's billing system 22. To insure the security of the information being transferred the information sent on the communications link is preferably encrypted.

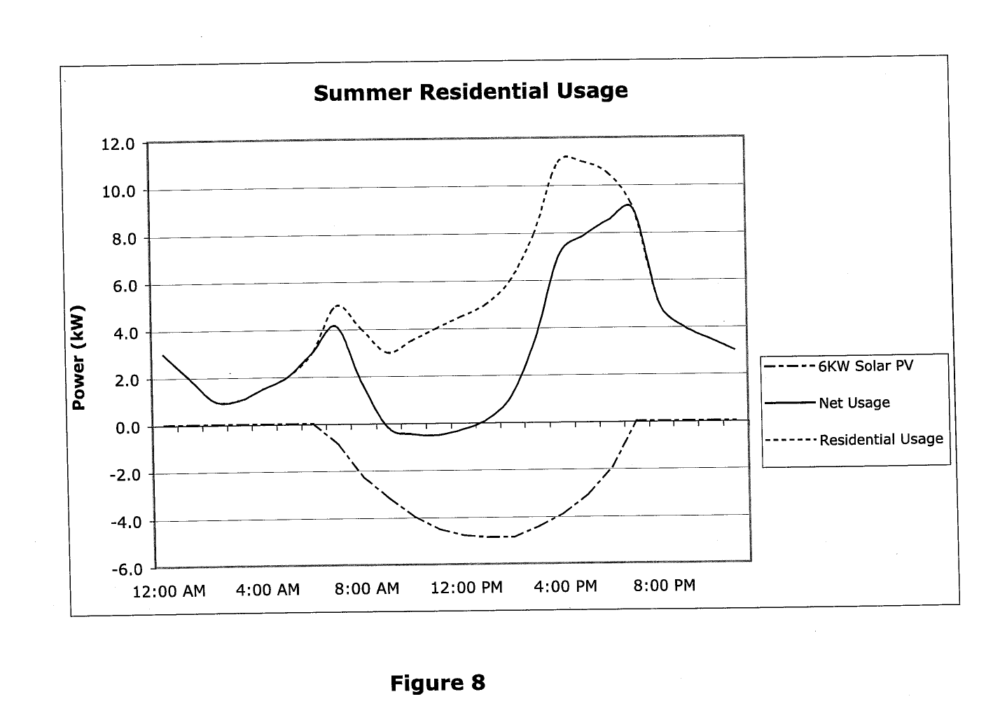

In addition to enabling Meter Aggregation to substitute for On-Site Net Metering, the data collected from meters 18 and 14 enables the MM&M company to generate usage and savings reports, community comparisons and other information helpful to the adoption of renewable energy, presented to the utility customers through the Internet 24 and Home Area Network/Internet Gateway 25. The details of these reports and interactions are presented in the discussion of FIG. 8.

Other information, specifically the energy generated by and status of inverter 17, and the consumption of air conditioning units, lights, refrigerators, washer/dryers, etc. in Residence 11 can be collected by the Home Area Network (HAN)/Internet Gateway 25 and transferred to the MM&M company 23 for several useful calculations and reports. In addition, if implemented with the Advanced Metering Infrastructure, the power metering data from meters 14 and 18 may be made available to the HAN and may be transferred to the MM&M company 23 via a secure alternate route comprising gateway 25 and Internet 24. This communication path may be very helpful in the event the AMI back haul 21 is not yet functional.

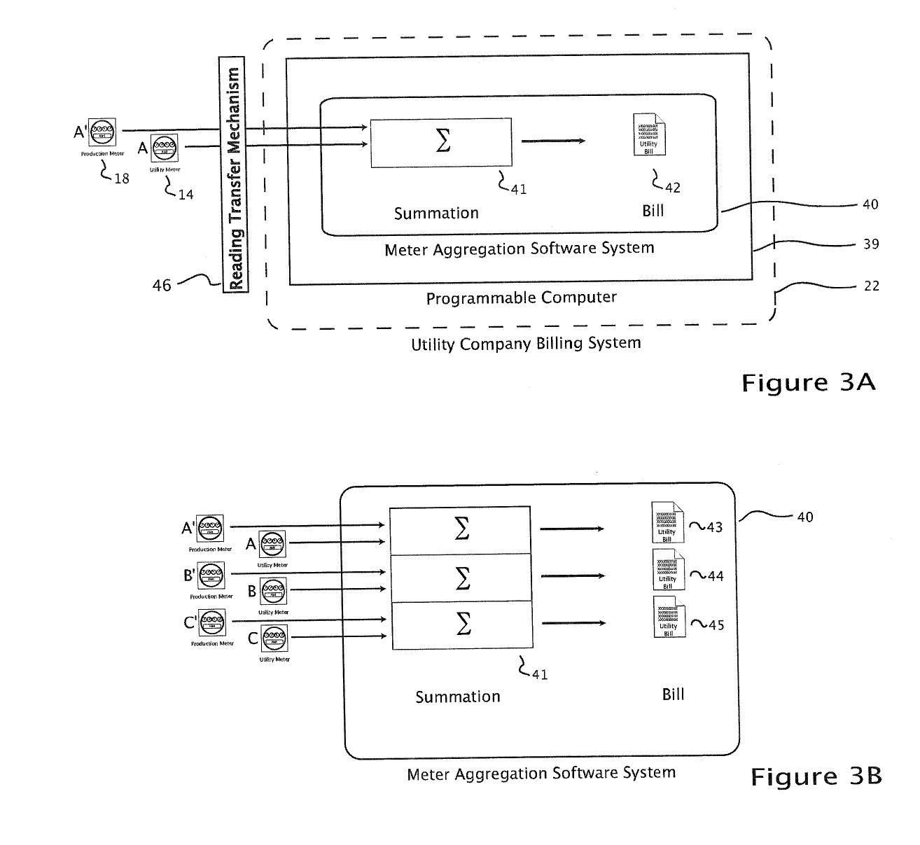

FIG. 3A presents a block diagram of a Meter Aggregation Software System 40 executable on a general purpose computer 39 preferably under the control of the utility's billing system 22 or alternatively under the control of MM&M company. The readings of the two meters, production meter 18 and utility meter 14 from FIG.2, are assigned in the Meter Aggregation Software System 40 to the same billing account. This assignment is performed by computer messaging from the MM&M company 23 or manually at the direction of the MM&M company. The readings from meters 18 and 14 can be transferred to billing system 22 via any of the reading transfer mechanisms 46 described in the preceding paragraph.

By convention, since utility meter 14 reflects a usage in kilowatt hours as a positive number, readings from production meter 18, which reflects kilowatt hours generated rather than consumed, will be a negative number. The outputs of the meters are mathematically summed at step 41 to create utility bill 42. This result is that utility bill 42 is the same as if the system was on-site behind the meter except for any adjustment for a utility retail wheeling charge described hereinafter that may apply, with Net Metering as described in the discussion of FIG. 1.

In the event the utility does not possess Meter Aggregation Software 40, the MM&M company 23 of FIG. 2 may perform this calculation by using a programmable computer and conventional software and, by agreement, present the results to the utility billing system for the creation of utility bill 42.

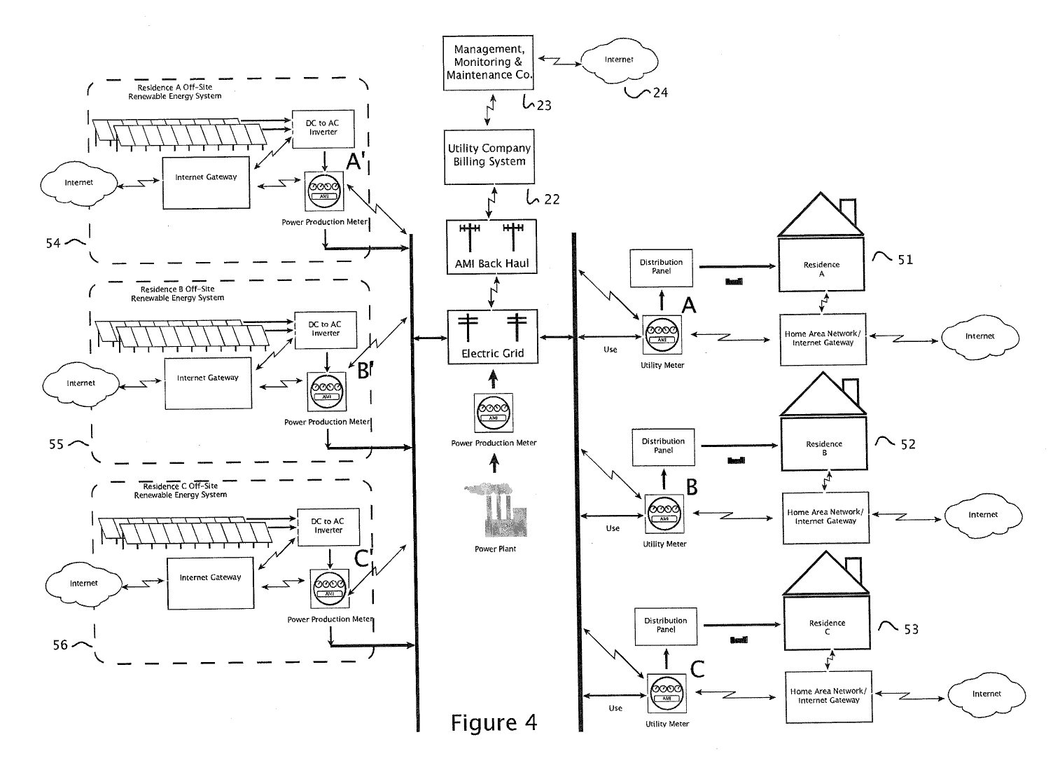

FIG. 4 presents the more generalized case where three Residences, 51, 52 and 53, are each associated with (or own) three Off-Site Renewable Energy Systems 54, 55, and 56, respectively. In this embodiment, each utility meter is paired with its corresponding production meter for a Residence and the MM&M company directs the utility billing system 22 to credit each Residence account accordingly.

FIG. 3B presents a block diagram of a Meter Aggregation Software System 40 with the pairings of FIG. 4. The conventional programmable computer on which the software executes and the utility's billing system are not shown for brevity. Again, the outputs of the meters are mathematically summed at step 41 for each customer to create utility bills 43, 44, and 45 for Residences A, B, and C, respectively. As related in the discussion for FIG. 3A, the MM&M company may perform this aggregation in the event the utility's billing system does not support Meter Aggregation.

Returning to FIG. 4, it should be noted that Renewable Energy Systems 54, 55, and 56 may be geographically dispersed, or may be physically located on the same tract or plot of land, which tract or plot would be chosen based on its providing optimal conditions for a centralized Renewable Energy System. The owner of the Renewable Energy System may also own the land, lease the land pursuant to a long-term lease from another party, or otherwise encumber the land. By locating each of the Renewable Energy Systems 54, 55, and 56 in side-by-side proximity to each other, efficiencies can be gained by not duplicating necessary infrastructure.

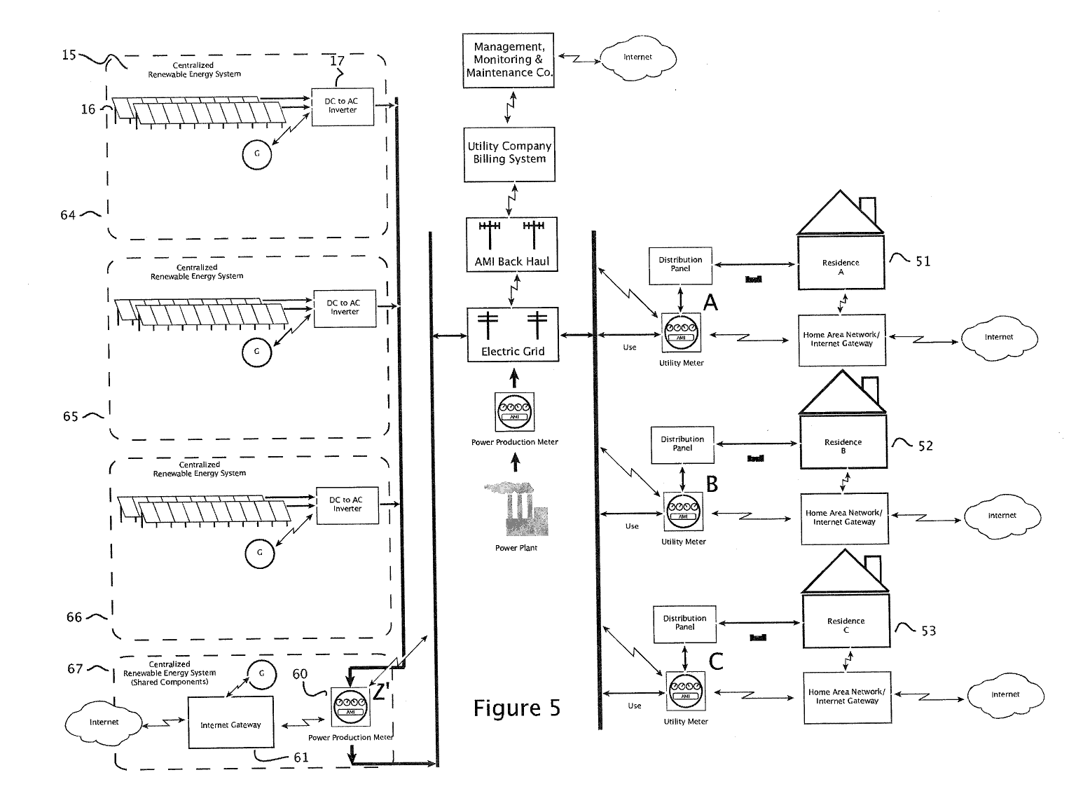

FIG. 5 presents an alternative embodiment of the present disclosure in which the multiple metering, and Internet gateways are eliminated. The meters of FIG. 4 may be removed and replaced by a single production meter 60, and the multiple gateways may be replaced by gateway 61. In this aspect of the disclosure, the customers in Residences 51, 52 and 53 may own Renewable Energy Systems 64, 65, and 66, respectively and possibly have a fractional or shared ownership interest in the common components 67, which includes meter 60 and gateway 61. The land on which Renewable Energy Systems 64, 65, and 66 are placed may be owned, leased or otherwise encumbered by their respective owners in Residences 51, 52 and 53. Since Renewable Energy Systems 64, 65, and 66 are no longer individually metered, the owners may enter into a power pooling agreement. The output of the single production meter 60 may be proportionally allocated to each of the Residences that have an interest, based upon the power generation potential of each Renewable Energy System compared to the total power generation potential of all the combined Renewable Energy Systems connected to single production meter 60. In the example presented in FIG. 5, each Renewable Energy System may be identical so each Residence (in the example) would own and be entitled to a 33.33% share of the total generated energy. In addition, each owner may also be provided with a 33.33% undivided, fractional ownership share in the common components 67 and the land on which the components are located. (The land on which common components 67 are placed may also be owned, leased or otherwise encumbered.) It is important to note, though, that at any point in time an individual Renewable Energy System 64, 65, and 66 may not be producing 33.33% of the total generated energy, due to localized component failure, maintenance issues, or temporary shading due to cloud passage (for solar PV). Alternatively, common components 67 may also contain a single, larger inverter, replacing Inverters 17 in Renewable Energy Systems 64, 65, and 66 (replacement not shown).

In another aspect of the present disclosure, the Renewable Energy Systems 64, 65, and 66 are not identical. In this case, the output of the single production meter 60 may be proportionally allocated based upon the power generation potential of each Renewable Energy System compared to the total. For example, if system 64 has a power generation potential of five kilowatts, system 65 three kilowatts, and system 66 two kilowatts, resulting in a total power generation potential of ten kilowatts, then the owners of Renewable Energy Systems 64, 65 and 66 would own 50%, 30% and 20% of the output respectively measured by single production meter 60, and respectively a 50%, 30% and 20% undivided, fractional ownership share in the common components 67.

The ownership structure shown in FIG. 5, which is a combination of private ownership of Renewable Energy Systems 64, 65, and 66 and undivided, fractional ownership of common components 67, can be implemented in many states using traditional real-estate based condominium law. In one aspect of the present disclosure, Renewable Energy Systems 64, 65, and 66 may be described and created under condominium statutes using three-dimensional metes and bounds (or other method of describing a real estate volume) and the individual solar panels or other components comprising the Renewable Energy System are placed within this three-dimensional volume. In like manner, a Condominium Owner's Association may be formed under the condominium statutes to administer and manage the shared ownership of the common components 67. The Condominium Owner's Association may contract with MM&M company 23 to perform this service.

The direct condominium ownership structure provides several benefits over other forms of ownership, such as indirect ownership. Direct ownership through the condominium ownership structure may qualify the customer for certain types of incentives, including tax credits and rebates. This is distinct from indirect ownership, in which a customer may hold a stock or share ownership of a separate legal entity, which in turn may be the single owner of a facility comprised of systems 64, 65, 66 and common components 67. In addition, direct ownership in combination with the proportional allocation described above may not be considered a security under the Securities Act of 1933 or states' securities laws, reducing costs and administrative burdens. Direct ownership may also be advantageous in regulatory environments where third party power providers are not allowed to interconnect to the utility grid.

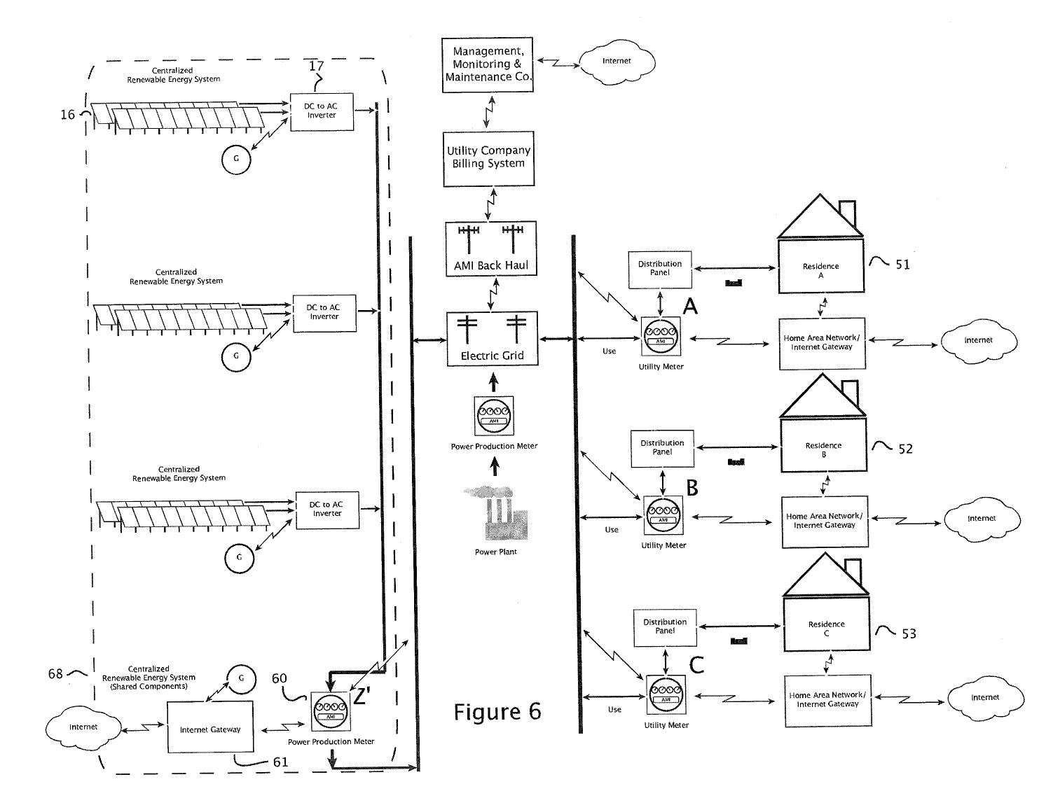

FIG. 6 depicts another embodiment of the present disclosure. FIG. 6 presents the physical configuration of FIG. 5, but where all owners have an undivided interest in an entire centralized Renewable Energy System 68, including the solar panels, inverters, meters, and gateways. The tract of land on which the centralized Renewable Energy System 68 is placed may also be owned, leased, or otherwise encumbered. Each Residence's fractional ownership would be based upon the purchase of shares of the total System, which are sold to the customer at the Residence in proportion to the amount of peak energy output desired by that customer. For instance, if the System 68 were an 18 kilowatt facility, and each of the three customers acquired a 6 kW share of the System, each would own 33.33% of the System 68 and each owns a 33.33% share of the electricity produced by the centralized Renewable Energy System 68. It is important to note that this fractional ownership is a direct ownership share of the underlying asset, as opposed to an entitlement to a fractional portion of the System 68's electricity output, with System 68 being owned by some other legal entity.

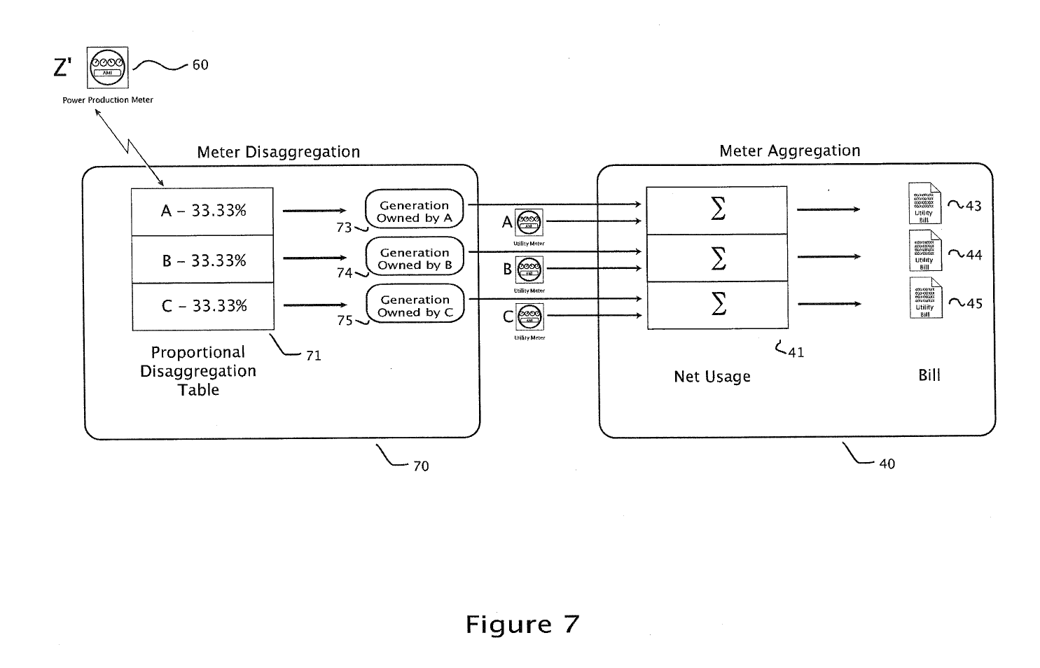

FIG. 7 presents a flow diagram of a conventional meter disaggregation software application 70 coupled with a conventional meter aggregation software application 40. The reading of production meter 60 may be allocated according to a disaggregation table 71. This table may be initialized as directed by the MM&M company, in proportion to each customer's percentage ownership of the energy as discussed in FIGS. 5 and 6 and measured by Power Production Meter 60. This produces energy production amounts 73, 74 and 75, which are then directed to the same meter aggregation software 40 discussed in FIG. 3B to produce the utility bills 43, 44, and 45. The result of this calculation mechanism used by the software applications may be described as “Virtual Net Metering”, “Community Net Metering”, or “Neighborhood Net Metering”. In the event the utility does not possess Meter Disaggregation Software 70 or Aggregation Software 40, the MM&M company may perform this calculation and present the results to the utility billing system for the creation of utility bills 43, 44 and 45. These calculations are typically performed once per billing period (monthly), but with the advent of the Advanced Metering Infrastructure, meters can be read and the calculations performed on much shorter time intervals.

FIG. 8 is an example of Residential Power Usage for a typical summer day, which presents the real-time relationship between a typical residential usage, power generated by a 6 kW PV system with typical summer insulation, and the Net Usage of the residence after the contribution of a Net Metered PV Renewable Energy System. The cumulative peak demand for power, which occurs in the mid to late afternoon, has to be planned for by the utility otherwise brownouts or blackouts may occur. A significant portion of the utilities' costs is a result of planning for peak demand. As a consequence of this phenomenon, electric utility companies may institute “Time-Of-Use (TOU)” tariffs and billing, in an effort to reduce demand. In Time-Of-Use (TOU) billing, the utility's charges for electricity consumed from the electric grid will vary depending on the time of day. Electricity prices are set generally higher during times of peak demand, in an effort to dissuade consumption. These prices may be as much as two to four times the average for the year. The usage (consumption) data as measured by the utility meters 14 may be collected on intervals as short as every 10 minutes. Conventional TOU billing calculations based on this usage data may also be performed at this same interval. A Net Metered Renewable Energy System based on Solar PV, such as that shown in FIG. 8, supplies energy at the times it is most expensive, significantly reducing the net cost to the consumer. The calculations presented in the discussion of FIG. 7 may be performed at this same time interval as well. The current disclosure enables those who cannot install a Net Metered Renewable Energy System based on Solar PV at their residences to also participate in this benefit.

FIG. 9 is a block diagram that shows the database structure of the software system 80 used in the implementation of the present disclosure. These databases reside on one or many programmable general-purpose computers that may be operated by the MM&M company. The software system 80, may be comprised of multiple databases 81, organized by function as shown in FIG. 9. The software system 80 produces outputs 82 by processing inputs 83 in combination with databases 81. In general, the software system 80 collects information from various information sources 84, which typically include the utility's computer system 85, the Residences' Home Area Network 86, and the Renewable Energy System 87. This data collection by software system 80 may be accomplished via two-way, secure network queries over the Internet or a private communications network (wireless, cellular, etc) 93 in a manner known in the art. Databases 81 are updated, and the software system 80 produces output 82 for the various information recipients 94, either delivering information as a result of a query, or as part of a scheduled service. Outputs may be produced for the following: the electric utility 88, the utility customer who are owners 89, the Residences 90, the Renewable Energy System 91, and the MM&M company 92. The MM&M company 23 may be retained to administer all operations of the System for its useful life, typically 25 years.

FIG. 10 is a block diagram that presents the various groups which may host or control the general purpose programmable computers used to operate the off-site or centralized Renewable Energy System and to carrying out the methods of the present disclosure. A group is an entity that is related by common interest and has identifiable goals and operations, without regard to its formal legal structure such as a corporation, association, LLC, or partnership. While the MM&M company typically may be the primary operator of the software system 80, the present disclosure contemplates that some other legal entity might physically hold and control the computers on which the Software System executes.

The Holding Group 100 physically holds the general purpose programmable computer 101 (which may be one or more physical computers) on which the software system 80 of FIG. 9 executes. This computer 101 may be configured as a web server, interfacing with other Groups described herein via the Internet or Private Network 102. The MM&M Group 103 may contract with the Holding Group 100 for use of the software and server computer, or may assume this responsibility itself. In addition, there may be two or more MM&M companies in Group 103, each responsible for a different Renewable Energy System.

Computer 101 is comprised of one or more processors 104, memory 105, storage units 106, network interfaces 107, and user interface items 108 (such as monitors, keyboards, and pointing devices). Databases 109, as well as applications and web servers 110, reside on storage units 106 on the computer 101, but are shown separately. The software system 80 of FIG. 9 primarily resides at location 110, but other components of the software system may execute on client computers as is common in the art.

The MM&M Group 103, the Project Group 112, the Finance Group 113, the Owner's Group 114 and the Utility Group 115 employ one or many general purpose computers 116, wherein each Group's computers have the hardware components corresponding to those of computer 101. The computer 117 in Utility Group 115 may be configured as a host server computer, rather than a web client computer as in the other Groups. However, it should be noted that in modern computer architectures, the distinction between server and client is becoming increasingly blurred. Servers can query other servers for information—in this role, it becomes a client to the remote server. Correspondingly, a server can answer a query from a remote server—in this role the remote server is a client of the local server. This is the relationship that may exist between the Holding Group 100's computer 101 and the Utility Group 115's server 117. In addition, it is anticipated that servers 116 are contained in the Finance Group 113.

Continuing with FIG.10, Project Group 112 may be the business entity that operates as the project developer of the off-site or centralized Renewal Energy System. In such a capacity, the Project Group develops the Renewable Energy System, determines the optimal ownership structure for a given regulatory jurisdiction and utility grid so that the utility customers that acquire ownership interest(s) in the System qualify for Net Metering at the residences and also qualify for the available incentives to reduce the financial investment they must make to obtain their interest in the Renewable Energy System, markets and sells interests to utility customers, secures financing for the project, coordinates the state and local incentives, constructs the Renewable Energy System, and perfects the various ownership and other property interests associated with the Renewable Energy System. After initiating a new Renewable Energy System, the Project Group may interact with Holding Group 100 and software system 80 to enable automated, web-based sales of the interests in the System that enable each the contracting customers at Residences to have renewable energy for offsetting its energy usage at the Residences and obtain a utility bill based upon Net Metering.

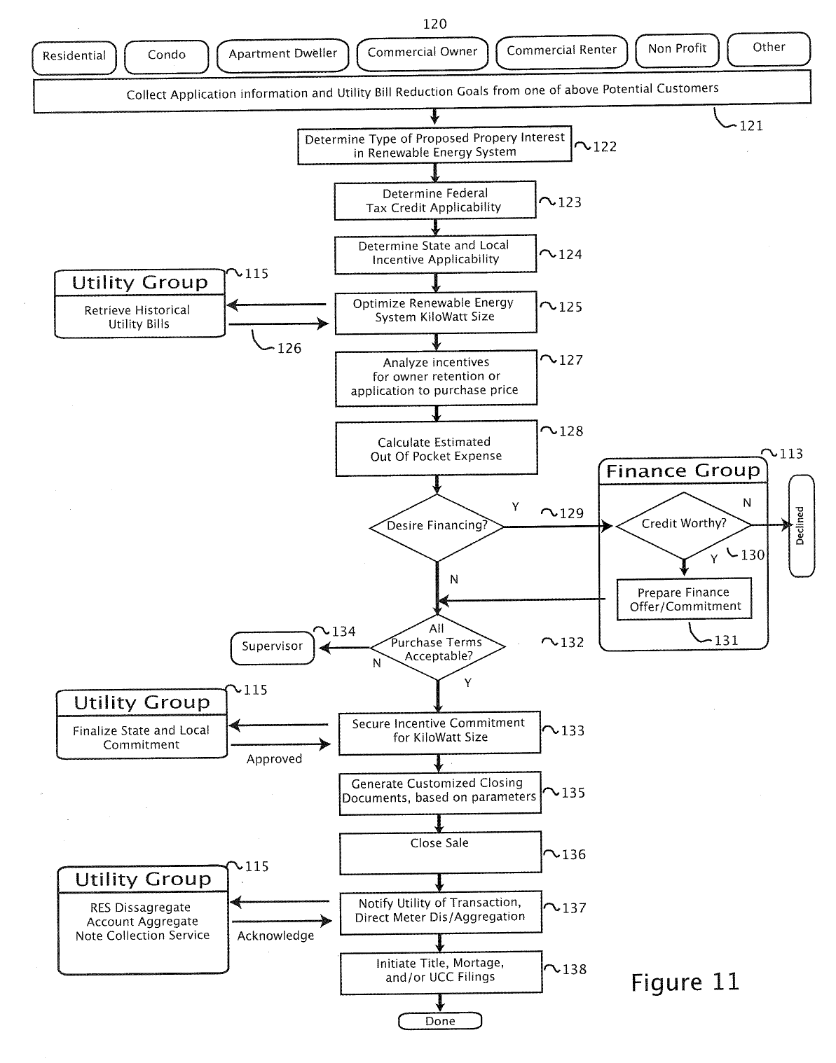

Software system 80 may also interact with Utility Group 115 and Finance Group 113 to automate the qualification, financing and sales process for each customer who wishes to participate in the Renewable Energy System as shown in the example Flow Diagram presented in FIG. 11. A suitable Finance Group is a financial institution that has committed to work with the Project Group and utility customers in a systematic way in order for utility customers to easily contract and obtain financing for an interest in the Renewable Energy System.

After all ownership interests or shares are sold or subscribed by utility customers, the Project Group 112 may transfer the responsibility for the Renewable Energy System and the Sites 30 (FIG. 2), 67 (FIG. 5), or 68 (FIG. 6), as applicable, to the Owners' Group 114. Such an Owner's Group 114 would typically represent the interests of the group of utility customers that have acquired interests in the Renewable Energy System through an appropriate structure, such as an owner's, community or cooperative association or partnership. The Owner's Group 114 may utilize software system 80 to self administer and maintain the Renewable Energy System, but may also contract with the MM&M Group 103 for day to day operational issues to manage, monitor and maintain the Renewable Energy System. In another aspect of the disclosure, after all ownership interests or shares are sold or subscribed to by utility customers, the Project Group 112 may also take on the role of the Owners' Group, to administer the long-term interests of the Owners.

After the Owners' Group 114 assumes responsibility for the Renewable Energy System, it is anticipated that a certain number of the property interests in the Renewable Energy System will undergo a change in ownership. As such, reassignment of the property interest in a component of the System or the energy generated by the System from the old owner to the new owner may be performed in coordination with the Utility Group 115. Whether performed directly by the Owner's Group 114, or by the MM&M Group 103 on behalf of the Owner's Group 114, the system software 80 may be used to direct Utility Group 115's billing system 117 to reflect the change in ownership in its Proportional Meter Disaggregation table and its Meter Aggregation table.

In addition, Utility Group 115 may be contracted by the Holding Group 100 or the MM&M Group 103 to bill and collect any mortgage or note payment from a participating utility customer who chose to finance a portion of their purchase, or to collect any fees due to the Holding Group 100, MM&M Group 103 or any association dues levied by Owners' Group 114. Software system 80 would account for and verify through secure financial networks the resulting monetary transfers from the Utility Group 115 to each of the recipient groups.

FIG. 11 is a flow diagram of the process that may be implemented by software system 80 to sell and perfect a property interest in the Renewable Energy System. Potential customers 120 are directed to the web page 121 of the software system 80. Information from the applicant is collected, such as the applicant utility bill reduction goals. It should be noted that while the steps shown in FIG. 11 are generally performed in sequence, potential customers 120 may create a user context with an individual log-on code and password. This context enables the potential customers to save the data collected in each step for use in a later session. This means the potential customer may not be required to complete the purchase in a single web browsing session. Permission is also obtained from the applicant customer for the operator of software system 80 to obtain past utility bill information from the utility. In Step 122, the software system uses this collected information to determine the optimal type of proposed interest in the Renewal Energy System, based upon the classification of the application (taxable or tax-exempt) and the applicable governmental regulatory requirements, utility requirements, and incentives provided by the utility and applicable governmental entities. In steps 123 and 124, the software system 80 determines the applicability of the primary financial incentives for customers acquiring an interest in the System, including the existing applicable federal Business Energy Investment Tax Credit (ITC) for renewable energy, or the Residential Renewable Energy Tax Credit (RRETC) for individuals and any governmental capacity or production-based incentives. The amount and applicability of these incentives will be used in Step 132 to calculate financial metrics, such as rate of return on investment, to aid the customer in their purchase decision. Step 125 optimizes the Renewable Energy System size in kilowatts for this applicant by examining their Historical Utility Bills as retrieved from the Utility Group 115 via computer network 126 in relation to applicant's utility bill reduction goals. Most jurisdictions do not allow a grid-connected owner to become a long-term net energy producer, and will withhold incentives or interconnection based on this.

Once the optimal Renewable Energy System size in kilowatts is selected, the system analyzes the incentive contributions (if any), and queries the applicant as to whether they prefer to retain them, or if they wish to assign them to the sale to reduce the out of pocket costs. (Due to the non-cash nature of the ITC, RRETC or state or local tax credits, these incentives may be subject to specialized financing.) Once known, the system calculates the out-of pocket cash contribution to the purchase price for the System required of the applicant in step 128. The applicant is asked if they desire financing of the out-of-pocket expense for the Renewable Energy System in step 129. If so, they are directed to Finance Group 113 via Internet for a credit check 130. If successful, the Finance Group prepares a finance offer and commitment, and the applicant is returned to the application process.

Step 132 presents the purchase terms to the applicant, along with several charts, graphs and tables to assist in their purchase decision. If the terms are acceptable, the process proceeds to step 133. If not, the applicant is directed to a human supervisor at step 134 for possible resolution.

Step 133 initiates a formal request to the Utility Group 115 to obtain a formal commitment for the State and Local financial incentive, based upon all criteria the Utility (or sponsoring entity) requires to fund the incentive. Once formal approval is obtained, the system software in step 135 generates customized closing documents, based upon all the parameters of the sale. In step 136, these documents are sent electronically to an agreed upon location, such as a Title Company, Bank, Notary Public, or other suitable location, the Renewable Energy System sale is closed, and the closing documents are formally recorded in the software system 80.

Step 137 notifies the Utility Group 115 of the Renewable Energy System sale, and directs the Utility to set up their Billing system to perform the Meter Disaggregation and Aggregation as discussed in FIG. 7, and to collect any dues or note payments as agreed to by the applicant. Lastly, in step 138 the system initiates any Title, mortgage, and/or UCC filings as necessary to perfect the sale.

In summary, the various alternative embodiments of the present disclosure enable the wide-spread mass adoption of renewable energy systems by existing and new utility customers by providing Residences with the ability of acquiring a property interest in an off-site renewable energy system wherein the energy output associated with the Residence may be used to reduce the Residence's consumption of energy from the utility and to reduce the Residence's utility bill based upon the Net Metering of the Residence's off-site renewable energy generation with the energy consumed locally by the Residence.

In order to implement the methods and systems of the present disclosure, the utility operating the utility grid to which the Residence is connected has to either 1) publish and implement a tariff of general applicability for the type of off-site centralized Renewable Energy Systems described hereinabove or 2) enter into an agreement with the Renewable Energy System operator that permits the Residences that acquire an interest in the off-site Renewable Energy System to receive and credit the Residence's energy contribution from the off-site System against the Residence's consumption of electricity from the utility's grid. This may be accomplished through a utility “net metering retail wheeling tariff” or comparable agreement with the utility operating the grid which governs the conditions under which the System is connected to the utility's grid to deliver the generated renewable energy to the retail customer.

To encourage cooperation by and to minimize utility charge from the utility serving the Residence, it is preferable that the “off-site location” for the Renewable Energy System is chosen 1) so that the electrical connection between the Residence and the System does not extend across utility regulatory boundaries, and 2) to minimize transmission losses. Such a site location enables any net metering retail wheeling agreement with a utility to be localized, thereby minimizing the financial impact while compensating the utility for the use of its electric grid. The location for the off-site System may then be optimized to maximize efficiency and minimize installation and operating and maintenance costs. Because at least a fractional part of the System is still owned by the Residence customer just as if it was onsite, the customer is able to secure all the incentives provided for an onsite renewable energy system, even though the Site on which the Residence is located might be unsuitable for a conventional renewable energy installation.

While the embodiments described are primarily directed at solar PV installations, one skilled in the art will immediately see this disclosure applies as well to other renewable energy applications, such as wind, biomass, or combinations thereof could easily be used.

The embodiments of the present disclosure may be easily adapted to support hundreds of Systems, each of a different size with components provided by different manufacturers and have different ownership structures to maximize the incentives afforded the customers with a property interest in the System, while realizing the economies of scale delivered by a single, large-scale project.

The systems and methods of the present disclosure thus provide for mass adoption of Renewable Energy Systems by existing and new utility customer, in part by providing:

1. An off-site Renewable Energy System that is built and operated as a single system, but is fractionally owned by individual commercial and/or residential utility customers;

2. A fractional allocation of the output of the off-site Renewable Energy System to each commercial or residential customer proportional to their ownership interest, to directly offset the amount of energy they consume, resulting in a net savings on their utility bill;

3. A business framework to administer the ownership of the system and allow a commercial or residential customer to capture all the incentives associated with renewable energy based upon individual or fractional ownership;

4. Financing methods for the customer's interest in the System that result in the customer having a mortgagable and foreclosable asset;

5. A highly efficient marketplace for the marketing, buying, selling, and trading of the customer's Renewable Energy asset and/or its associated cash flow;

6. A software system which proportionally disaggregates the meter reading from the Renewable Energy System and allocates and aggregates the energy generated with the individual customer meter readings for utility bill reconciliation, provide and/or verify “time of use” metering, automate the total record keeping for ownership and changes in ownership and service locations and the necessary interactions with the utility's billing system, provide insight for the end-customer on their consumption habits and alert them to abnormal patterns, provide status and performance monitoring for the renewable system, provide demand side modification suggestions to customers to minimize their bill, provide a portal to Home Area Networks utilizing the Advanced Metering Infrastructure, and, where jurisdictions allow, dynamically allocate the ownership interests to maximize the collective utility savings of the customer owners;

7. A MM&M company that is owned or contracted to administer all operational aspects of the system;

8. A net metering retail wheeling agreement with the local utility, implemented though the computerized interaction with the billing system, compensating them for the use of their transmission and distribution system for grid access; and

9. A billing agreement with the host utility compensating the utility for aggregating the customer consumption with the renewable generation, collecting any note payments, dues or operating fees the MM&M company may require, and forwarding those payments to the MM&M company.

Although the inventions have been described with reference to specific embodiments, these descriptions are not meant to be construed in a limiting sense. Various modifications of the disclosed embodiments, as well as alternative embodiments will become apparent to persons skilled in the art upon reference to the description. It should be appreciated by those skilled in the art that the conception and the specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims.

It is therefore, contemplated that the claims will cover any such modifications or embodiments that fall within the true scope of the invention.

What is claimed is:

1. A system for providing input of energy into a utility grid from an off-site renewable energy source, wherein the source is owned by a plurality of customers of the utility grid whereby the connection of the source to the grid and the connection of the grid to each customer's utility meter are within the same regulatory jurisdiction, the system comprising:
one or more advanced metering infrastructure compatible power meters at the off-site source location electrically linked to one or more renewable energy production devices and electrically linked to the utility grid, wherein the power meter output is disaggregated by the utility company's billing system to credit a predetermined fraction of the total energy output to each owner's account by aggregation of the energy use indicated by each owner's utility meter less the credit due each owner from the off-site renewable energy source power meter.

2. The system of claim 1, further comprising a management system comprising:
a host computer system comprising one or more processors, memory, computer readable media with storage for one or more databases, one or more network interfaces;
an electronic link from the host computer to the utility grid operator's billing system computer, effective to receive and to transmit billing and energy usage data comprising meter usage and charges for customers connected to the utility grid;
wherein the host computer comprises computer readable media with software instructions encoded thereon to retrieve energy use data from each owner's utility meter and energy output from the off-site power meters and calculate the aggregated utility use less energy input credit for each owner and transmit the sum to the utility company's billing system.

3. The system of claim 2, wherein the host computer further comprises computer storage media with one or more databases to store utility production and use data and computer readable memory with software instructions encoded thereon to monitor energy production by the off site renewable energy source and to generate usage and savings reports from data stored in the databases.

4. The system of claim 1, wherein the off-site renewable energy source is a production facility comprising a plurality of customer owned lots, each with one or more renewable energy production devices located thereon and a separate power production meter electrically connected to the production devices on each customer owned lot.

5. The system of claim 1, wherein the off-site renewable energy source is a production facility comprising a plurality of customer owned lots, each with one or more renewable energy production devices located thereon and a commonly owned advanced metering infrastructure compatible power production meter electrically connected to every owner's renewable energy production devices.

6. The system of claim 5, wherein customer ownership is structured as direct condominium ownership.

7. The system of claim 1, wherein the off-site renewable energy source is a production facility comprising a plurality of renewable energy production devices located on a commonly owned site and a commonly owned advanced metering infrastructure compatible power production meter electrically connected to the renewable energy production devices, wherein the power meter output is disaggregated in the utility billing system to credit each owner with a predetermined percentage of the total energy output.

8. The system of claim 1, wherein the power production devices comprise solar panels connected to a DC to AC converter.

9. The system of claim 1, wherein the power production devices comprise one or more wind turbines.

10. A system for management of an off-site renewable energy production facility connected to a utility grid, wherein the production facility is owned by customers of the utility grid in which the connection of the production facility to the grid, and the connection of the grid to the customers' utility meter are within or are enabled by the same regulatory jurisdiction, the system comprising:
one or more host computer systems comprising one or more processors, memory, user input devices, computer readable media with storage for one or more databases, and one or more network interfaces; and
an electronic link from the host computer to the utility grid operator's billing system computer, effective to receive and to transmit billing and energy usage data comprising meter usage and charges for customers connected to the utility grid, wherein the total energy output from the off-site renewable energy production facility is disaggregated to credit each owner with a predetermined percentage of the total energy output;
wherein the host computer comprises computer readable media with software instructions encoded thereon to retrieve energy use data from each owner's utility meter and the disaggregated energy output data from the off-site power meters and to calculate for each owner, the sum of the owner's energy use less the energy input credit for each owner.

11. The system of claim 10, comprising a host computer comprising computer readable media with software instructions encoded thereon to provide an online application and approval process for purchase of a portion of the off-site renewable energy production facility comprising the following steps:
providing a graphical user interface through an internet connection accessible by applicants for ownership of a portion of off-site renewable energy property;
collecting application data and utility bill reduction goals from applicants through the internet connection;
determining type of proposed interest in the renewal energy system based on applicant information;
determining federal tax credit applicability;
determining state and local tax credit applicability;
electronically retrieving applicant historical utility bills;
calculating proposed renewable energy system kilowatt size for purchase based on historical utility bills of applicant;
calculating available owner incentives and applying incentives to purchase price;
calculating estimated investment required for purchase;
providing an interface to a financing institution to consider an application for financing of the purchase;
displaying financing offer and commitment from financing institution to applicant;
displaying purchase terms to applicant and to provide electronic interface for applicant to indicate acceptance of terms;
communicating with utility group computer to obtain state and local tax incentive commitments and to secure commitments for incentives to applicant for proposed kilowatt generation;
generating customer closing documents;
providing interface for applicant to complete and submit closing documents to close sale;
notifying utility provider of transaction to configure disaggregation of production meter and aggregation of utility bill; and
initiating title, mortgage, universal commercial code filings or a combination thereof.

12. The system of claim 11, wherein the ownership interest a direct condominium ownership.

13. The system of claim 10, wherein the off-site renewable energy production facility comprises solar panels electrically connected to the grid through a DC to AC converter and an advanced metering infrastructure compatible power output meter.

14. The system of claim 10, wherein the off-site renewable energy production facility comprises one or more wind turbines connected to the grid through a DC to AC converter and an advanced metering infrastructure compatible power output meter.

15. A method of applying off-site renewable energy to a utility user's total utility bill to reduce the user's net energy consumption charges while permitting the user to obtain incentives for the off-site renewable energy interest, the method comprising:
providing an off-site renewable energy production facility connected to a utility grid where the connection of the off-site renewable energy production facility to the grid and the connection of the user's utility meter to the grid are within or are enabled by the same regulatory jurisdiction;
providing to a plurality of users the purchase of a fractional interest in the off-site renewable energy production facility such that the total energy output of the facility to the grid is disaggregated and credited to each purchaser in accordance with the percentage of ownership purchased by each user after subtraction of any applicable fees;
providing an aggregated utility bill to the users in which each user's total utility bill includes a credit for the user's percentage of the total energy output subtracted from the user's utility usage.

16. The method of claim 15, wherein the applicable fees comprise utility wheeling charges or management fees.

17. The method of claim 15, further comprising providing an electronic interface through which utility users can apply for and purchase fractional ownership in the off-site renewable energy production facility, wherein the electronic interface provides:
connection to a source for obtaining the user's historical energy use to use in calculating an appropriate maximum amount of energy output to be purchased to avoid allowing a user becoming a net provider of energy to the grid;
an offer for sale of a fractional ownership of the off-site renewable energy production facility at a predetermined price;
connection to a source for calculating and obtaining tax incentives for renewable energy production;
calculation of a net purchase price including subtraction of the available tax incentives;
connection to a source for financing the purchase;
all forms for closing the financing and the purchase; and
initiation of title, mortgage, universal commercial code filings or a combination thereof for the user.

18. The method of claim 15, further comprising providing an electronic interface for owners of a fractional interest in the off-site renewable energy production facility to offer all or part of that interest for sale to other users within the same utility jurisdiction.

19. The method of claim 15, further comprising providing management services to the owners of the off-site renewable energy production facility, wherein the services comprise at least one of managing and maintaining the off-site facility, monitoring energy production of the facility, interfacing with the utility company to manage billing and credits including utility bill aggregation, interfacing with taxing agencies to manage tax incentive transactions, maintaining and enforcing power pooling agreements between owners, managing any commonly owned property at the off-site renewable energy production facility, or any combination thereof.

20. The method of claim 15, wherein the purchase is structured as a direct condominium ownership agreement.
